(19) United States
(12) Patent Application Publication
(10) Pub. No.: US 2026/0071395 A1
(43) Pub. Date: Mar. 12, 2026

(54) SOUND INSULATION DEVICE WITH VIBROACOUSTIC METAMATERIALS

(71) Applicants: AUTOBAHNEN- UND SCHNELLSTRASSEN-FINANZIERUNGS-AKTIENGESELLSCHAFT, Wien (AT); Fraunhofer-Gesellschaft zur Förderung der angewandten Forschung e.V., München (DE)

(72) Inventors: Sebastian RIESS, Darmstadt (DE); Heiko ATZRODT, Darmstadt (DE); Daria MANUSHYNA, Darmstadt (DE); Marvin DROSTE, Darmstadt (DE); William KAAL, Darmstadt (DE); Peter RATH, Wien (AT); Karl ZEILINGER, Rohrendorf (AT); Ralf LAFER, Pischelsdorf (AT)

(21) Appl. No.: 18/869,891

(22) PCT Filed: May 25, 2023
(86) PCT No.: PCT/EP2023/064092

§ 371 Date: Nov. 24, 2025

(30) Foreign Application Priority Data
May 27, 2022 (DE) 10 2022 205 321.4

(51) Int. Cl. E01F 8/00; G10K 11/172

(52) U.S. Cl. CPC E01F 8/0082; G10K 11/172

(57) ABSTRACT

A sound insulation device (1) for reducing sound transmission, comprising an arrangement of mechanical resonators (2), which each contain at least one vibrating mass (3) and a spring element (4), wherein the mechanical resonators (2) are each tuned such that each resonator has at least one natural frequency in a relevant frequency range, wherein the arrangement of mechanical resonators (2) is configured such that it generates at least one stop band for the propagation of waves in the relevant frequency range.

The invention relates to a sound insulation device based on vibroacoustic metamaterials and to a noise barrier containing said metamaterials.

Noise protection is relevant in many areas of everyday life when it comes to protecting people and the environment from the negative effects of increased noise levels. Noise protection is therefore particularly relevant in road traffic, where noise is primarily caused by rolling and drive noise, as well as aerodynamic noise from vehicles. This noise is loudest in the frequency range from 500 Hz to 1000 Hz. In order to protect people and animals from road noise, noise barriers are used to damp the propagation of sound, in addition to options for reducing noise emissions from roads and vehicles. However, noise protection is also relevant in other areas, for example on building sites, in industry, in open-plan offices or in the construction industry in general. Sound insulation devices, damping elements such as façades, partition walls, windows and doors or other components that act in a similar way to noise barriers are also used in these areas.

Conventional noise barriers reduce sound transmission by increasing the mass per unit area, i.e., by increasing the wall thickness or by using high-density materials. Particularly low transmission values are therefore achieved with concrete noise barriers, for example. Sound transmission may also be reduced by improving the absorption properties of the noise barrier. Absorbent materials such as mineral wool, which are used in noise barriers in cassette construction, are used for this purpose, as is the integration of earth walls or vegetation into the noise barrier. Other options for improving the absorption properties are the use of porous materials, membranes or Helmholtz resonators. However, the resulting noise barriers always have the disadvantage that they are very bulky and require a lot of material. In addition, they usually have to be solid and expansive, so that they have a negative impact on the landscape.

Another option for damping sound propagation that has not yet been widely used in noise protection is the use of vibroacoustic metamaterials. Metamaterials are artificial, usually periodic, structures that are configured to achieve special conductive, insulating, damping or reinforcing properties. In this way, for example, structures may be provided that form stop bands. Stop bands are frequency ranges in which wave propagation is greatly attenuated. In vibroacoustic metamaterials, these concepts are used to control and manipulate the propagation of elastic and acoustic waves.

The properties of solid bodies, such as density, compression modulus and modulus of elasticity, are relevant in this context. A simple example of such a metamaterial is a structure made of materials with periodically changing refractive indices, realized in the acoustic range, for example, by jumps or inhomogeneity in the elastic parameters of a structure. Bragg scattering occurs in such a structure: The sound waves are reflected at the transitions of the refractive indices depending on the frequency. In certain frequency ranges, which depend on the lattice structure of the inhomogeneities, destructive interference occurs, resulting in a stop band. Periodic arrangements of resonant structures, so-called local resonators, are one way of generating stop bands using vibroacoustic metamaterials. Due to the interactions of the local resonators with their environment, the resulting structure behaves in a certain frequency range as if it had a negative effective mass, so that wave propagation is strongly hindered for this range. In order to generate a strong stop band, the individual resonators must all be tuned to the same frequency. Deviations in the periodicity and frequency tuning of the resonators result in a wider but weaker stop band. By skillfully designing vibroacoustic metamaterials, these effects are able to be exploited to create structures with particularly low sound transmission.

The object of the present application is therefore to propose a sound insulation device which, compared to conventional sound insulation devices, offers an improved reduction in sound transmission with a lower mass per unit area. This means that mass and material may be saved in the construction of noise barriers and improved, partially transparent noise barriers may be created.

This object is achieved by a sound insulation device according to independent claim 1.

Such a sound insulation device comprises
an arrangement of mechanical resonators, which each contain at least one vibrating mass and a spring element,
wherein the mechanical resonators are each tuned such that each resonator has at least one natural frequency in a relevant frequency range,
wherein the arrangement of mechanical resonators is configured such that it generates at least one stop band for the propagation of waves in the relevant frequency range.

The sound insulation device comprises an arrangement of mechanical resonators. This arrangement of mechanical resonators forms a vibroacoustic metamaterial. The arrangement may be two-dimensional, i.e., in the plane, or three-dimensional in space. In particular, several two-dimensional arrangements may be stacked on top of or next to each other. The individual resonators each consist of at least one vibrating mass and one spring element. The vibrating mass may have any shape and dimensions and be made of different materials. The mass of the vibrating mass is an important factor in the frequency tuning of the resonator. The spring element has elastic properties. The spring element may be formed in one part with the vibrating mass. It may also be a single elastic element, such as a leaf spring or coil spring. The spring element may have any shape and dimensions. In particular, the shape and dimensions of the spring element are important factors in the frequency tuning of the resonator. The spring element may be made of the same material as the vibrating mass or, for example, may also be an elastomer. It should be noted that vibrating mass and spring element are not necessarily clearly distinguishable from each other. The vibrating mass and spring element may be formed in one part and the vibrating mass may also deform during vibration. The vibrating mass, the spring element and a certain area of the resonator's surroundings form a unit cell of the resonator. The arrangement of mechanical resonators consists of a spatial repetition of these unit cells.

Each individual resonator has at least one first relevant resonant frequency. When excited at a resonant frequency, the amplitude of the resonator's vibration is maximized. The resonant frequency of a resonator is determined by the properties of the entire unit cell. In addition to the mass of the vibrating mass and the spring element and the elastic properties of the spring element, the geometry, mass and elasticity of the surrounding structures also play a role.

The frequency of the resonators may therefore be tuned by varying these properties. The unit cells should be dimensioned in the order of half a wavelength of the first relevant frequency, or smaller.

All mechanical resonators of the metamaterial are tuned to the same, or at least approximately the same, resonant frequency. This creates a stop band around this frequency, which greatly attenuates wave propagation in the metamaterial. By tuning the resonance frequency of the mechanical resonators, a stop band may be provided that reduces the transmission and reflection of sound waves in the sound insulation device and in associated components. If the resonators have several resonant frequencies in the relevant frequency range, several stop bands may occur around them. These several stop bands may separately reduce vibrations in different frequency ranges or overlap to form a large stop band.

The arrangement of mechanical resonators may be periodic. A periodic structure results from the spatial repetition of the unit cells of the mechanical resonators.

The distance between the mechanical resonators in the arrangement of mechanical resonators may be less than half a wavelength of the first relevant frequency in order to ensure favorable behavior of the arrangement.

The periodic arrangement of the mechanical resonators with distances of less than or equal to half a wavelength may also ensure that at least one additional stop band is formed in the sound insulation device, which is created by Bragg scattering at the arrangement. In this way, an additional stop band around an additional frequency may be utilized.

Additional stop bands may also be generated by forming the mechanical resonators in such a way that they have several resonant frequencies. Furthermore, the arrangement of the mechanical resonators may be selected in such a way that additional resonant frequencies result for the arrangement, either by using resonators with different relevant frequencies in the arrangement or by using additional stop bands due to the shape of the arrangement.

If the individual mechanical resonators are tuned slightly differently, the stop band around the first resonant frequency may be widened. However, it also loses its sharpness and the reduction of vibrations in this frequency range is less pronounced. However, these effects may be desirable. In addition, slightly different frequency tuning of the resonators may be useful in order to adapt the resonators to their position in the arrangement of local resonators, for example if it is expected that additional forces will act on certain areas of the arrangement.

In addition to the vibrating mass and spring element, the resonators may also include a damping element. This may be a viscoelastic material, for example, which is introduced into the unit cell. The shape of the stop band may be influenced by damping. Additional damping of the resonator widens the stop band, which may be a desirable effect.

The mechanical resonators may be embodied in such a way that their frequency tuning is unable to be changed by external influences. External influences are, for example, weather or external mechanical influences. For this purpose, the mechanical resonators may have an encapsulated form or enclosure or be arranged in such a way that they are protected from wind, weather or the accumulation of dirt. This is particularly important when using the sound insulation device in outdoor areas, such as in road traffic, where it is exposed to the weather and temperature fluctuations as well as dirt from the road and air, and yet reliable function over a long service life is desired.

There are various forms of mechanical resonators that may be arranged in a sound insulation device. These may be selected depending on the purpose of the application, the location of the sound insulation device and, in particular, the planned size of the overall arrangement of mechanical resonators. Different forms of resonators, which nevertheless have the same or at least similar frequency tuning, may also be combined in an arrangement, for example to fulfill mechanical or aesthetic requirements. In addition, resonators may be formed in such a way that they influence the sound reflection. The mechanical resonators described here enable stop bands in frequency ranges between 50 Hz and 5000 Hz, in particular in the range between 1000 Hz and 1500 Hz.

The mechanical resonators may be configured as cup resonators, for example. In a cup resonator, a cup-shaped, elastic membrane forms the spring element and a vibrating mass is arranged inside this cup. If such an arrangement is applied to a surface, it may be completely sealed off from the outside, providing protection against external influences. In addition, such a cup resonator may be easily manufactured and dimensioned for the relevant frequency range. A cup may be understood here to be dome-shaped, cylindrical or truncated cone-shaped. The cup does not necessarily have to have a circular or even round basic shape, but this may be useful for frequency tuning. The cup has an open and a closed side. The closed side may be flattened or rounded and provided with concentric waves to reduce rigidity or similar decorations. On the open side, the wall of the cup forms a collar with which the resonator may be easily attached to a surface, for example by gluing or screwing.

In a cup resonator, the cup may be formed as a spring element in one part with the vibrating mass. Die casting or injection molding processes, for example, are suitable for manufacturing such a cup resonator.

Steel, zinc, aluminum or other metals and plastics may be used as materials. Zinc is particularly suitable because of its low modulus of elasticity and only slightly lower density compared to steel, which makes it ideal for use as an elastic membrane for the resonator. Zinc also acts as corrosion protection and thus offers additional weather resistance. A one-part cup resonator offers the advantages of a small number of parts and simple assembly with relatively simple large-scale production.

Instead, the cup and vibrating mass may also be configured as individual parts, wherein the mass is secured in the cup. The cup may consist of a molded sheet metal, for example. It may also be manufactured from plastic using the injection molding process. On the other hand, a material with a significantly higher density, such as steel or lead, may be selected to produce the mass, which opens up more possibilities for frequency tuning. The mass is arranged in the cup and firmly connected to it, for example by screwing or gluing. If the cup is manufactured using the injection molding process, the mass element may be overmolded and thus connected to the cup during this manufacturing step. As plastic cups may also be produced in composites, this cup resonator may also be easily realized in large-scale production.

In another form of a mechanical resonator that may be used for a sound insulation device, the spring element is configured as an elastomer. In its simplest form, for example, a vibrating mass may be connected to a surface by means of an elastomer body and thus be mounted so that it is capable of vibrating.

Another form of such a resonator is the vibrating mounting of a mass element between two elastomers, encapsulated by a housing. This means that the vibrating mass is mounted so that it may vibrate stably in one direction. The resonator is also protected from the weather by a housing. Instead of an elastomer, for example, a compression spring, a fiber pad, a metal pad or a metal cushion may also be used. Although this form of resonator has a larger number of components, these are simple and readily available parts with which a good frequency tuning may be achieved due to the large variation possibilities. If the resonators are individually embodied in housings, they may be easily attached to a surface. In addition, an arrangement of such mechanical resonators results in a particularly good ratio between the free area and the area required for the resonators. This may be advantageous as, in combination with transparent materials, it enables the construction of transparent and partially transparent noise barriers.

A sheet metal strip may also serve as the spring element of a mechanical resonator. This may also act as a vibrating mass or may be provided with an additionally attached vibrating mass. In the simplest case, this arrangement acts as a leaf spring with a vibrating mass at one end or in its center. However, a longer sheet metal strip may also be either bent or provided with support elements in such a way that it has several resilient areas to which individual masses are applied, for example glued, screwed or welded. In this way, a large-area arrangement of resonators may be easily realized and applied to a surface as a composite. This results in a lot of free space between the sheet metal strips.

Another form of mechanical resonator comprises a surface from which a one-part resonator has been machined so that parts of the surface defined by cutouts are capable of vibrating. For example, the sound insulation device may be made from a metal sheet from which an entire arrangement of resonators is cut out using laser or water jet cutting or punching. The individual resonator consists here of an area of the surface that is defined by cutouts. A first portion or several first portions of this area connect(s) a second portion as a vibrating mass to the remaining surrounding surface as a spring element. This arrangement of resonators may be easily produced over a large area. Individual areas may also be provided with additional weights. As this type of resonator is susceptible to dirt accumulating in the cutouts, but also has an extremely flat form, it is particularly suitable for use inside multi-layer components.

In another form of resonator, a steel cable acts as a spring element and the vibrating mass is suspended from it. Steel or lead balls, for example, may be used as vibrating masses. The steel cable is tensioned between two support elements. The frequency may be tuned using the pre-stress and the mass. A steel cable already has damping due to its inherent friction. The steel cable may also be supported by several supporting elements, so that one steel cable may act as a spring element for several resonators, making it easy to create a large-area arrangement of local resonators. This embodiment of the mechanical resonators also results in a good free area ratio.

A mechanical resonator may also be realized by embedding a vibrating mass in absorption material. The absorption material, for example mineral wool, acts as a spring element. The vibrating masses may be steel or lead balls, which are arranged at specific distances from each other in the matrix of the absorption material. In this way, a sound insulation device may be integrated into the standard cassette construction of noise barriers. In particular, this form of mechanical resonator may be combined well with other forms of mechanical resonators that are mounted on the surface of a cassette.

The mechanical resonators of the sound insulation device may each additionally comprise an element for energy conversion, so that the vibrations of the resonators may be utilized for energy generation.

The mechanical resonators may also include elements for adjusting their natural frequency. This may be achieved by varying the spring stiffness of the spring elements. For example, the pre-stress of the spring elements may be adjusted. In this way, active or passive readjustment may be realized depending on external requirements, such as the current traffic situation. It is also conceivable to use actuators that actively apply forces to the sound insulation device and thus influence or favor the formation of the stop band. Such actuators could improve the performance of the sound insulation device, in particular the width and depth of the stop band.

One possible application of the sound insulation device described is in noise barriers. The sound insulation device described may be combined with all standard forms of noise barriers. In the case of concrete noise barriers, the mechanical resonators may be cast into the concrete or applied to external surfaces. In the case of noise barriers in cassette construction, the resonators may be fitted in the cassettes or on their surfaces, or integrated directly into surfaces and filling materials. The arrangements of mechanical resonators may also be applied to noise barriers made of wood, glass or plastic composites, or arranged in cavities of these. Complete noise protection enclosures and tunnel walls may also be provided with a sound insulation device. Corresponding noise barriers are mainly used in road traffic, but the use of the described sound insulation device should not be limited to this. Other locations for use include airports, seaports and railway lines.

The sound insulation device may be arranged at least in some areas on the outside of a noise barrier. When arranged on a side facing away from the sound source, this mainly results in a reduction in sound transmission; when arranged on a side facing the sound source, sound reflection may also be reduced. Mechanical resonators in cup form, simple resonators with springs or elastomers accommodated in housings and sheet metal strips with applied vibrating masses are particularly suitable for applying the sound insulation device to the outside of the noise barrier.

If the noise barrier has a sandwich structure, such as a noise barrier in cassette construction, in which the noise barrier consists of several layers of materials, the sound insulation device may be arranged in one of the inner layers or may form one of them. The mechanical resonators made of sheet metal strips with applied masses, the resonators machined out of a surface and the resonators formed by mass balls embedded in absorption material are particularly suitable for this arrangement of the sound insulation device. The noise barrier may also comprise, as an inner layer, a cavity or several cavities, in which the sound insulation device may be arranged. In this way, the mechanical resonators of the sound insulation device may vibrate freely, but are still protected from external influences. Resonators in the form of steel cables with masses suspended from them are particularly suitable for this type of noise barrier.

The noise barrier may also comprise several layers on which sound insulation devices are mounted or which are formed by sound insulation devices. Different types of sound insulation devices may be combined with each other. In particular, sound insulation devices with stop bands in different frequency ranges may be combined with each other to create a noise barrier that reduces sound propagation in several ranges. In this way, specific sound insulation devices may also be used to reduce the transmission and reflection of sound at the noise barrier.

The noise barrier may include cutouts, such as windows, in which the sound insulation device is arranged. In this way, the noise barrier may be formed to be more open and allow sight lines through the noise barrier without sacrificing sound insulation. Arrangements of mechanical resonators with a high free area ratio, such as steel cables with suspended masses or sheet metal strip resonators, are particularly suitable for this type of noise barrier.

The noise barrier may also generally be made of a transparent material such as glass or a corresponding plastic. As the sound insulation device is applied to the noise barrier as an arrangement of mechanical resonators and this may have a relatively high free area ratio, this results in at least a partially transparent noise barrier.

The noise barrier may be retrofitted with a sound insulation device. However, the noise barrier may also be produced in such a way that the sound insulation device is permanently integrated into it. This makes it possible to better harmonize the construction of the noise barrier with the function of the sound insulation device. In particular, some forms of the sound insulation device may be formed in one part with the noise barrier.

Although the function of the sound insulation device has been described so far using the example of a noise barrier, the sound insulation device may also be used for other components that are intended to separate two areas spatially and acoustically. These include, in particular, windows, doors, dry walls, façades, machine housings, movable or partition walls and mobile noise barriers.

The described embodiments of the subject matter of the present application may be used individually or combined to achieve additional effects and to provide a sound insulation device which is provided with an arrangement of mechanical resonators.

The above-mentioned and other aspects of the invention will become apparent from the detailed description of the exemplary embodiments given with the aid of the following drawings, in which:

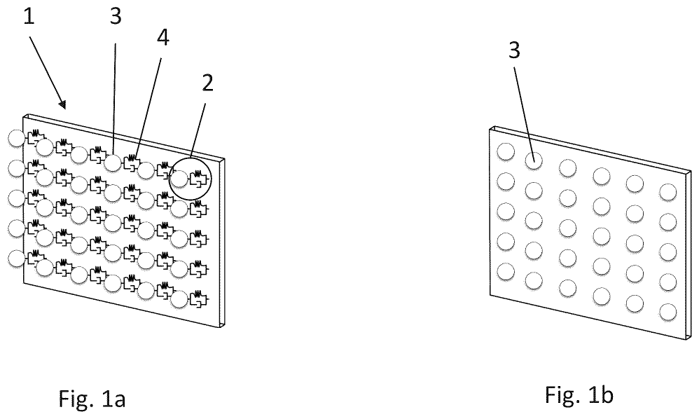

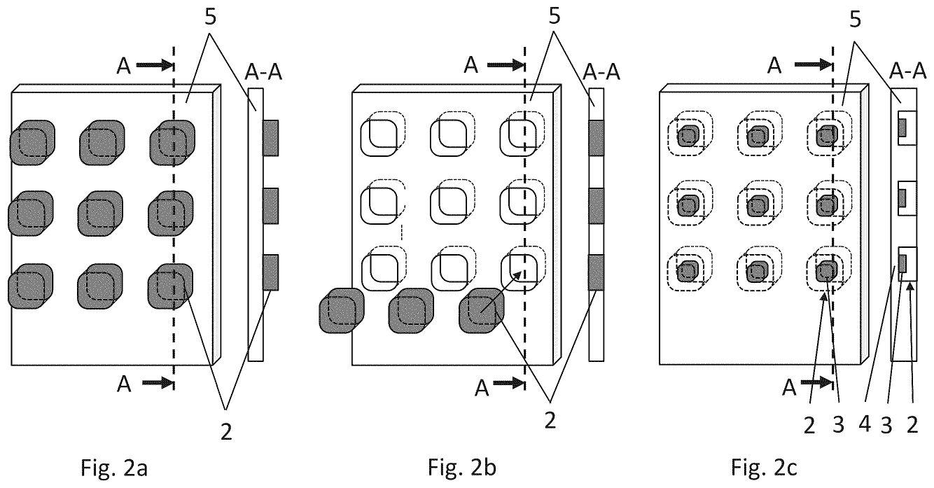

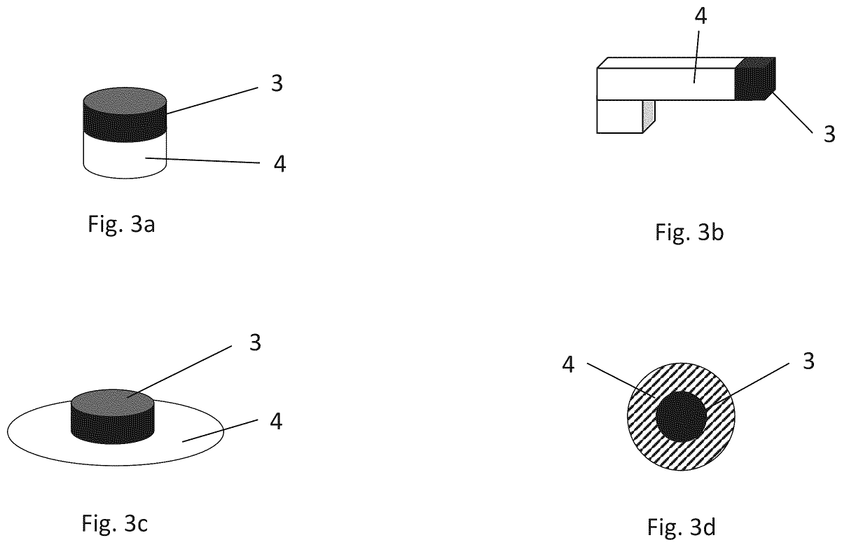

FIGS. 1a and 1b illustrate the operating principle of a vibroacoustic metamaterial, FIGS. 2a, 2b and 2c illustrate various general embodiments of a noise barrier with vibroacoustic metamaterials, FIG. 3a to 3d illustrate various relevant forms of mechanical resonators,

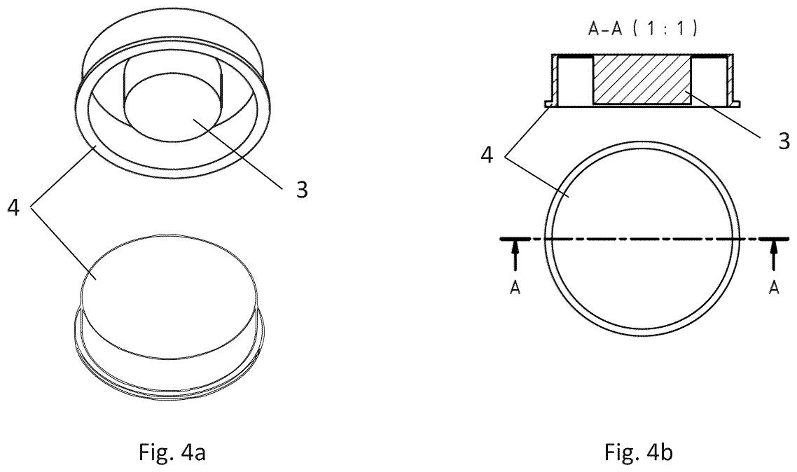

FIG. 4a shows two perspective views of a first form of a cup resonator, and

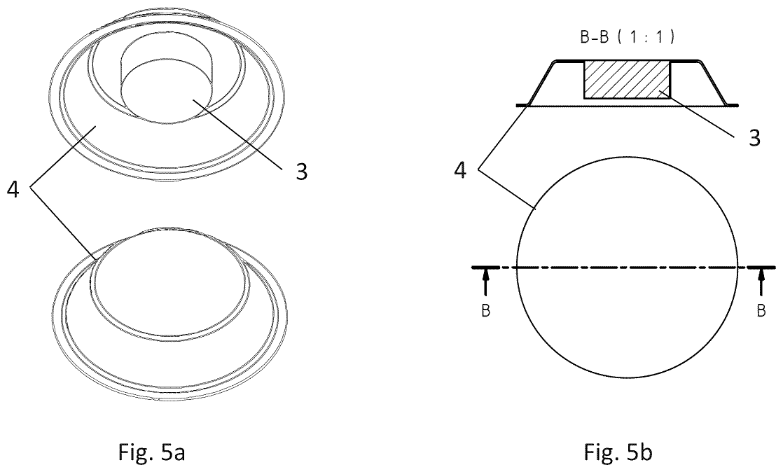

FIG. 4b shows a cross-section through the cup resonator from FIG. 5a,

FIG. 5a shows two perspective views of a second form of a cup resonator, and

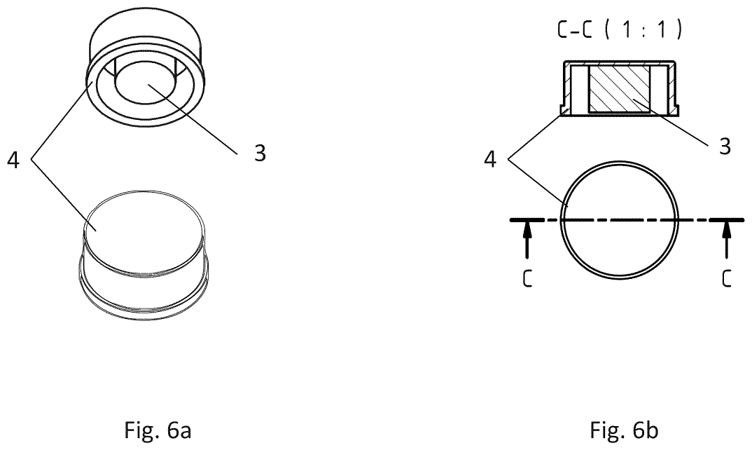

FIG. 5b shows a cross-section through the cup resonator from FIG. 6a,

FIG. 6a shows two perspective views of a third form of a cup resonator, and

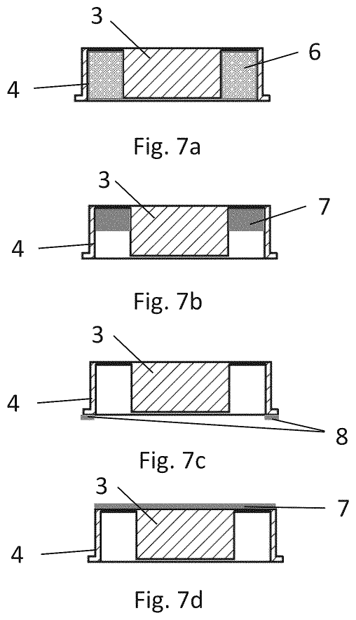

FIG. 6b shows a cross-section through the cup resonator from FIG. 7a,

FIGS. 7a, 7b and 7c show three different damping options using the example of a cup resonator,

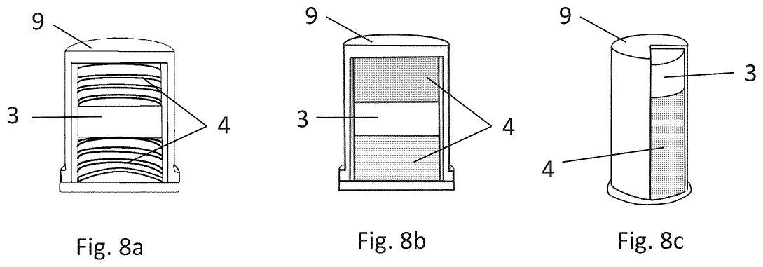

FIG. 8a shows a cross-section through a mechanical resonator with a spring as a spring element,

FIG. 8b shows a cross-section through a mechanical resonator with an elastomer as a spring element,

FIG. 8c shows a perspective view of a mechanical resonator with a metal foam as a spring element,

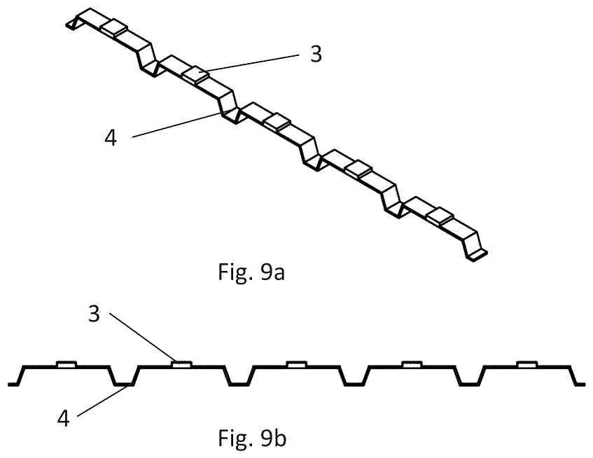

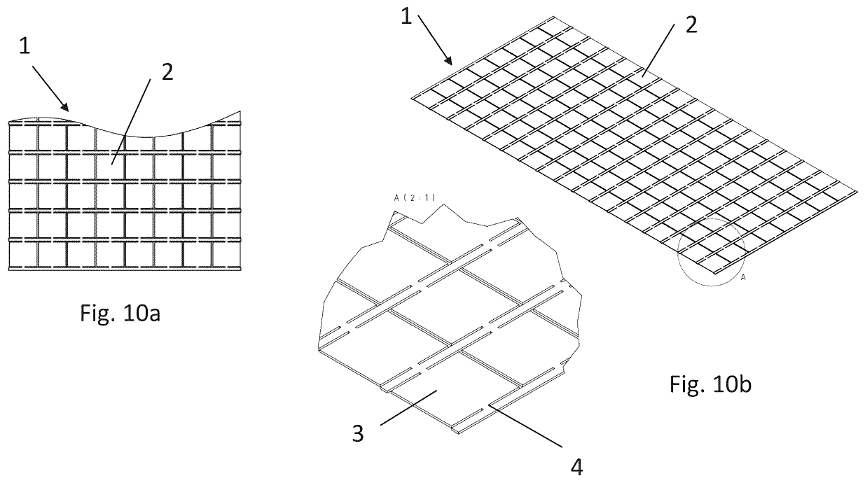

FIG. 9a is a perspective view of a mechanical resonator consisting of a sheet metal strip with attached masses, FIG. 9b is a side view of the mechanical resonator consisting of a sheet metal strip with attached masses, FIG. 10a is a plan view of an arrangement of mechanical resonators machined from a metal sheet, and

FIG. 10b shows a perspective view of the arrangement with an enlargement of a portion,

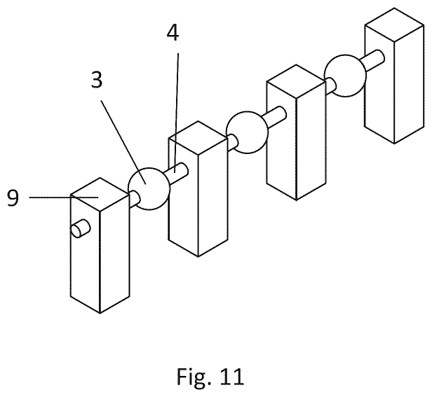

FIG. 11 shows a schematic representation of mechanical resonators with a steel cable as a spring element,

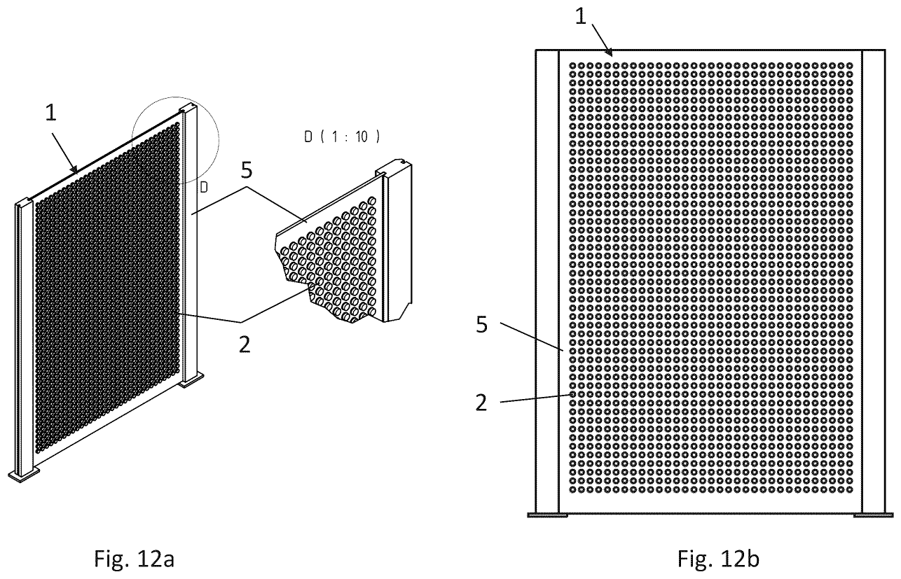

FIG. 12a shows a perspective view of a noise barrier provided with a sound insulation device, and

FIG. 12b shows a frontal view of the noise barrier,

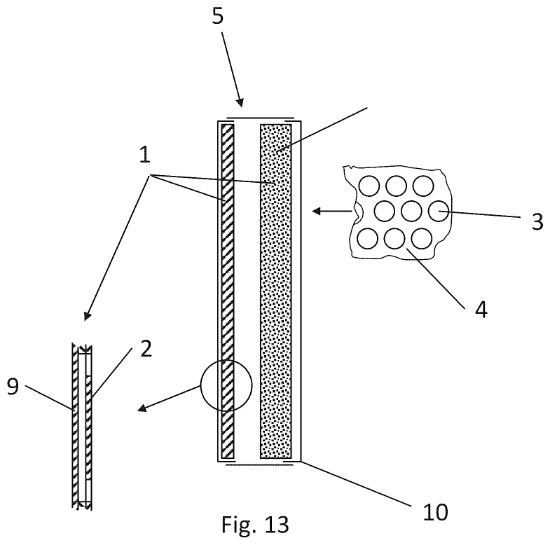

FIG. 13 shows a cross-section through a noise barrier in cassette construction with two different sound insulation devices,

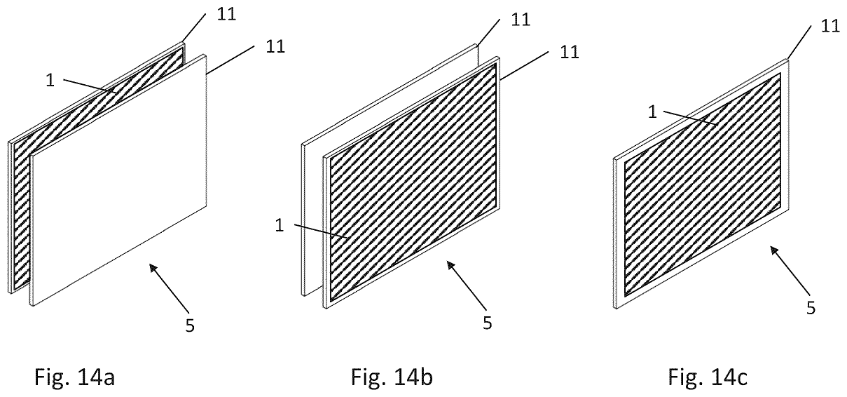

FIG. 14a shows a schematic representation of a multi-layer noise barrier with an internally arranged sound insulation device,

FIG. 14b shows a schematic representation of a multi-layer noise barrier with an externally arranged sound insulation device,

FIG. 14c shows a schematic representation of a single-layer noise barrier with a sound insulation device arranged on it,

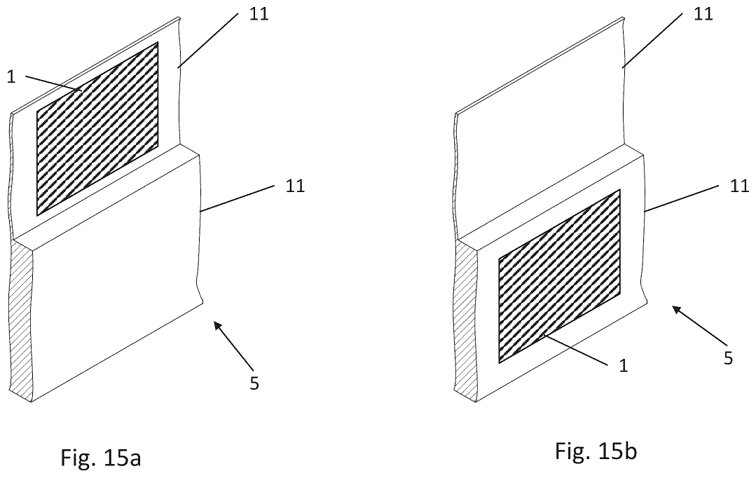

FIGS. 15a and 15b show schematic representations of noise barriers that are provided with a sound insulation device in some areas,

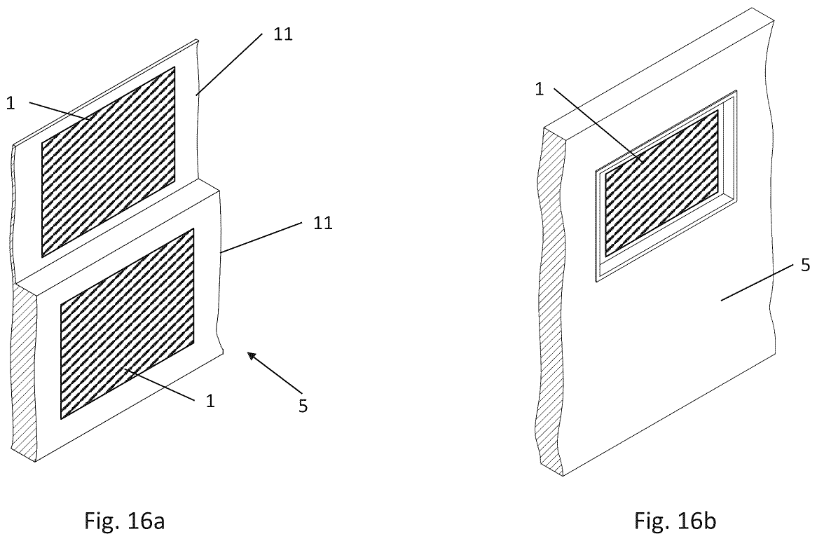

FIG. 16a shows a schematic representation of a noise barrier provided with a sound insulation device on two different areas,

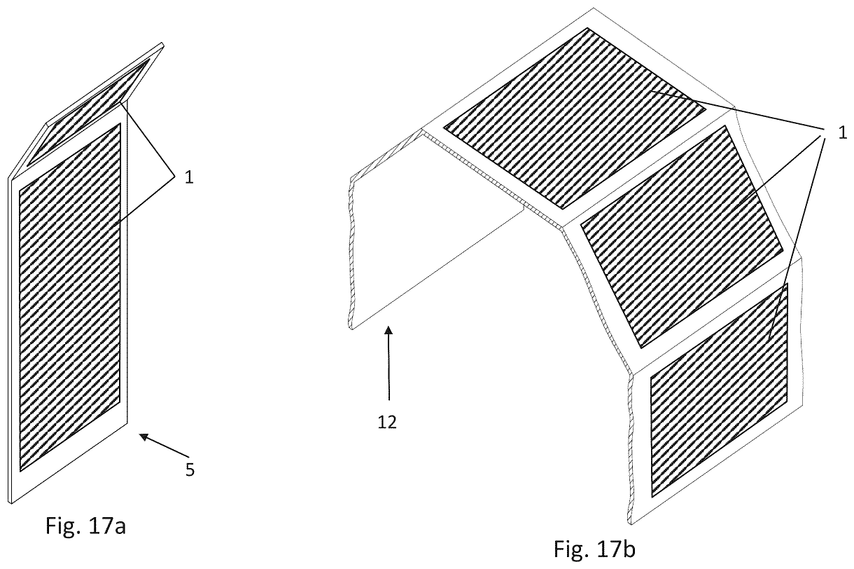

FIG. 16b shows a schematic representation of a noise barrier comprising a window provided with a noise barrier device, FIG. 17a shows a schematic representation of an embodiment of a curved noise barrier provided with a noise barrier device, and

FIG. 17b shows a schematic representation of a noise protection enclosure provided with a sound insulation device.

In the following, the claimed subject matter will be explained in greater detail on the basis of the accompanying drawings. Like reference signs refer to like elements.

FIGS. 1a and 1b show the general structure and operating principle of vibroacoustic metamaterials in abstract form.

FIG. 1 shows a vibroacoustic metamaterial based on resonant structures, so-called local resonators. In this context, these are mechanical resonators 2.

These each comprise a vibrating mass 3 and a spring element 4. The arrangement of mechanical resonators 2 is periodic. If the mechanical resonators 2 all have the same frequency tuning, i.e., they all have at least one common natural frequency, when they are excited at this frequency a stop band is formed around it in the arrangement of mechanical resonators 2 and in the medium coupled to it. The propagation of waves in this frequency range, i.e., in the acoustic range of structure-borne and airborne sound, particularly in the range from 50 Hz to 5000 Hz, is therefore greatly reduced. In this range, the structure may practically not be excited to vibrate. As the mechanical resonators 2 may also have several natural frequencies depending on their embodiment, several stop bands may also form around other frequencies. These stop bands may cover different frequency ranges or overlap to create an enlarged stop band. The individual mechanical resonators 2 may also be embodied with a slightly different frequency tuning. This indeed weakens the vibration reduction in the stop band range, but the stop band is widened. The arrangement shown in FIG. 1a thus represents the most general form of sound insulation device. This sound insulation device 1 is independent of its application and does not have to be mounted on a noise barrier 5, but may also be used in other areas. It is initially only defined by the fact that it comprises an arrangement of mechanical resonators that have the same frequency tuning.

FIG. 1b shows an additional vibroacoustic metamaterial based on the effect of Bragg scattering. This effect is caused by periodically occurring jumps in the phase velocity of waves in a medium, such as those generated by the periodic arrangement of masses 2. The reflection of the waves at these inhomogeneities results in destructive interference in certain frequency ranges, depending on the distances between the inhomogeneities, so that a stop band is also generated. The distance between the inhomogeneities corresponds to half the wavelength of the frequency of the stop band. This effect is of course also present in more complex arrangements, as shown in FIG. 1a. In the context of the present application, however, Bragg scattering plays a rather subordinate role, since the sound insulation device always comprises an arrangement of mechanical resonators 2. However, the Bragg scattering may be used to form additional stop bands.

In FIGS. 2a, 2b and 2c, various basic embodiments of a noise barrier 5 with a sound insulation device 1 based on vibroacoustic metamaterials are shown schematically in perspective and in cross-section. FIG. 2a shows a noise barrier 5 with mechanical resonators 2 mounted on it (shown in abstract form). In FIG. 2b, the mechanical resonators 2 are installed in the noise barrier 5. In FIG. 2c, the mechanical resonators 2 are integrated into the noise barrier 5 in that spring elements 4 are machined out of it in some areas, here in the form of a thinning of the wall thickness, and vibrating masses 3 are applied to these. However, the masses 3 could also be formed in one part with the noise barrier 5. The mechanical resonators 2 may be connected to the noise barrier 5 by means of adhesive bonding, screwing or other joining methods.

Various concepts of mechanical resonators that may be used in a sound insulation device 1 are described below. These may be roughly categorized into four different types, which are shown schematically in FIGS. 3a to 3d. FIG. 3a shows a columnar resonator in which a vibrating mass 3 is mounted on a discrete spring element 4. This shape is easy to realize and theoretically possible without additional mass 3. Coil springs, elastomers or metal cushions and foams, for example, are conceivable as spring elements 3. FIG. 3b shows a bending beam resonator. Here, the majority of the beam is marked as spring element 4 and provided with a mass 3 at the tip. However, these do not have to be discrete components; a continuous beam is also conceivable. For this reason, spring element 4 and vibrating mass 3 are unable to be strictly separated in this configuration. A bending beam resonator may easily be manufactured generatively from a plastic using laser cutting or forming processes from sheet metal. FIG.

3c illustrates a membrane resonator. A vibrating mass 3 is mounted on a membrane as a spring element 4. The membrane does not have to be flat, but may take on various shapes. However, the membrane must have elastic properties. The vibrating mass 3 may be glued, screwed or otherwise connected to the membrane, or may also be formed in one part with it. FIG. 3d shows a resonator consisting of a vibrating mass 3 and an elastic medium surrounding it as a spring element 4. In a resonator of this shape, the vibrating masses are practically embedded in the spring element.

Membrane resonators as shown in FIG. 3c have proven to be particularly advantageous for use in a soundproofing arrangement. These may be manufactured as cup resonators in which the membrane is molded into a cup-shaped spring element 4 in which the vibrating mass is arranged. This shape of the resonator makes it possible to construct the mechanical resonator 2 to be closed off from the outside, so that it is protected from external influences.

Embodiments of such cup resonators are shown in FIGS. 4a to 6b.

FIGS. 4a and 4b show a cup resonator in which the vibrating mass 3 and the cup are formed in one part as a spring element 4. FIG. 4a shows two perspective views of the resonator, both from diagonally below and from diagonally above. FIG. 4b shows a cross-section through the resonator along line A-A. As this cup resonator is formed in one part, mass 3 and spring element 4 do not need to be connected by additional means. As is visible, the mass 3 is centered in the cup of the spring element 4. To adjust the natural frequency of the resonator, the membrane thickness, the diameter of the cup and the diameter or mass of the vibrating mass may be varied. The cup resonator may also be provided with concentric waves (not shown) on its outer surface in order to reduce the stiffness of the spring element 3. Die casting or injection molding processes, for example, are suitable for manufacturing such a cup resonator. Steel, zinc, aluminum or other metals and plastics may be used as materials. Zinc is particularly suitable because of its low modulus of elasticity and only slightly lower density compared to steel, which makes it ideal for use as an elastic membrane for the resonator. Zinc also acts as corrosion protection and thus offers additional weather resistance. A one-part cup resonator offers the advantages of a small number of parts and simple assembly with relatively simple large-scale production. The lower collar of the cup resonator allows easy application, for example by gluing or screwing, to a surface such as a noise barrier.

FIGS. 5a and 5b show a cup resonator in which the cup is formed as a spring element 4 from a sheet metal and the vibrating mass 3 is centered in it and firmly connected to it. FIG. 5a shows two perspective views of the resonator, both from diagonally below and from diagonally above. FIG. 5b shows a cross-section through the resonator along line B-B. As this cup resonator is in two parts, mass 3 and spring element 4 must be connected by additional means. The mass 3 may be glued to the cup, for example, but may also be welded or screwed. To adjust the natural frequency of the resonator, the membrane thickness, the diameter of the cup and the diameter or mass of the vibrating mass may be varied. The cup resonator may also be provided with concentric waves or other embossments (not shown) on its outer surface in order to reduce the stiffness of the spring element 3. For the production of such a cup resonator, for example, a metal sheet may be used, which is formed into a cup in a reshaping process. On the other hand, a material with a significantly higher density, such as steel or lead, may be selected to produce the mass, which opens up more possibilities for frequency tuning. This embodiment of the resonator is easy to manufacture using sheet metal and simple reshaping processes. The lower collar of the cup resonator allows easy application, for example by gluing or screwing, to a surface such as a noise barrier.

FIGS. 6a and 6b also show a cup resonator, the cup as spring element 4 and the vibrating mass 3 are manufactured as individual parts. In this case, the spring element 4 is realized as a plastic cup in which the mass 3 is secured. FIG. 6a shows two perspective views of the resonator, both from diagonally below and from diagonally above. FIG. 6b shows a cross-section of the resonator along line C-C. The plastic cup is manufactured using an injection molding process. The mass 3 is glued to the cup or is molded around the plastic during the manufacture of the cup and thus permanently bonded to it. To adjust the natural frequency of the resonator, the membrane thickness, the diameter of the cup and the diameter or mass of the vibrating mass may be varied. The cup resonator may also be provided with concentric waves or (not shown) on its outer surface in order to reduce the stiffness of the spring element 3. Various plastics with elastic but durable properties are suitable for the manufacture of such a cup resonator. On the other hand, a material with a significantly higher density, such as steel or lead, may be selected to produce the mass, which opens up more possibilities for frequency tuning. By using an injection molding process, this form of cup resonator may be produced in composites and thus easily mass-produced. The lower collar of the cup resonator allows easy application, for example by gluing or screwing, to a surface such as a noise barrier. Similarly to the plastic cup resonator shown in FIGS. 6a and 6b, a cup resonator may also be formed from a metal foam, in which the membrane of the cup consists of a metal foam.

FIGS. 7a to 7c illustrate various possibilities for damping a mechanical resonator 2 in a sound insulation device 1 using the example of a cup resonator. However, these damping options may also be applied to other types of mechanical resonators 2. In FIG. 7a, the cavity of the cup is filled with a damping foam 6. In FIG. 7b, a damping element 7 made of an elastomer or silicone is inserted into the resonator. In FIG. 7c, the resonator is damped by the fact that it is connected to its base via elastic bonds 8. In FIG. 7d, a damping element is applied to the membrane of the resonator. This may be a layer of bitumen, for example, which additionally seals the resonator and protects it from corrosion. Depending on the shape of the mechanical resonator 2, other forms of damping are also possible. However, these all have the same effect of influencing the shape of the stop band of the sound insulation device 1. In particular, the stop band is weakened by the damping (loses depth), but also widens, which may be a desirable effect. By using damping elements, the shape of the stop band may therefore be specifically adapted to the respective application. FIGS. 8a, 8b and 8c show the different mechanical resonators 2, each of which may be assigned to the type of column resonator shown in FIG. 3a. FIGS. 8a and 8b are similar in that they each comprise a housing 9 in which a vibrating mass 3 is arranged between two spring elements 4.

In FIG. 8a, the spring element 4 is configured as a coil spring, in FIG. 8b as an elastomer. However, metal cushions could also be used instead of elastomers. The arrangement with the vibrating mass 3 between two spring elements 4 ensures a uniform pre-stress of these, which also allows the frequency tuning to be adjusted. In FIG. 8c, the spring element 4 is a metal foam. Metal foams have an inherent damping effect and are easy to process on a large scale. In addition, a metal vibrating mass 3 may be molded directly onto the metal foam and thus firmly bonded to it. The mechanical resonator 2 is encapsulated by the housing 9 and protected from external influences. Since these embodiments of the mechanical resonator 2 use standardized and readily available components, they are easy to manufacture and versatile in use.

FIGS. 9a and 9b show a resonator or an arrangement of resonators based on a sheet metal strip. A sheet metal strip may be understood as a bending beam resonator as shown in FIG. 3b. In the embodiment shown in FIG. 9a, however, it also has the characteristics of a membrane resonator as in FIG. 3c. Because the metal strip is folded several times, it defines a series of spring elements 4, each of which is provided with a vibrating mass 3. The masses 3 may be glued or screwed to the sheet metal strip. In this way, an arrangement of resonators 2 may be created using a sheet metal strip and applied in a composite. If damping is required, this may be achieved by elastically bonding the sheet metal strip to the substrate. A further advantage of this embodiment is that there is a relatively large amount of free space between the individual sheet metal strips in an arrangement of such mechanical resonators 2.

Another embodiment based on a metal sheet is shown in FIGS. 10a and 10b. Here, an arrangement of mechanical resonators 2 is machined out of the surface of a metal sheet. Laser or water jet cutting or other machining processes may be used to produce such a resonator arrangement. In this way, sound insulation devices 1 with large-area arrangements of mechanical resonators 2 may be manufactured in just one step. As may be seen in the magnification in FIG. 10b, cutouts in the sheet metal define plate-shaped vibrating masses 3 and spring elements 4 in the form of webs, which connect the masses to the remaining surface of the sheet metal. However, vibrating masses 3 and spring elements 4 are unable to be defined discretely, as both parts of the arrangement deform when the resonator 2 is excited to vibrate. Frequency tuning is achieved by selecting the shape and dimensions of the vibrating masses 3 and spring elements 4. Due to the relatively low mass of the individual resonators 2, a relatively large surface area is required in this version of a sound insulation device 1, resulting in a low free area ratio. However, this type of resonator may also be made very thin and may therefore be easily integrated into other components, such as noise barriers 5 in cassette construction. To protect against external influences, this form of sound insulation device 1 should be encapsulated as a whole. In addition, the entire metal sheet must be supported over its edges in such a way that the individual mechanical resonators 2 are capable of vibrating. This embodiment has been described here using the example of a metal sheet. However, it may also be realized in other surfaces and materials in which two-dimensional resonators may be defined by cutouts.

FIG. 11 shows a further embodiment in which a mechanical resonator 2 may be easily extended to form an arrangement of resonators 2. The spring element 4 here is a steel cable that is tensioned between support elements 9 and from which a vibrating mass 3 is suspended. The steel cable may thus serve as a spring element 4 for several resonator unit cells. The frequency tuning may be adjusted by the masses 3 and the pre-stress of the steel cable. The steel cable already provides inherent damping due to internal friction. A two-dimensional arrangement of mechanical resonators 2 may be easily achieved by using several steel cables arranged in parallel. This form of sound insulation device also offers a good free area ratio.

FIGS. 12a and 12b show an overview of a simple noise barrier 5 provided with a sound insulation device 1. The mechanical resonators 2, which are distributed over the surface of the noise barrier 5, may be, for example, cup resonators, as in FIG. 4a to FIG. 6b, or column resonators, as in FIGS. 8a to 8c. Since the sound insulation device 1 forms a stop band for sound propagation in a relevant area in the noise barrier 5, this reduces sound transmission and may be less massive than conventional noise barriers or have a higher sound transmission reduction. It may also consist of glass or another transparent material. Even with the sound insulation device 1 fitted, the noise barrier is then at least partially transparent and restricts lines of sight to a lesser extent.

FIG. 13 shows a cross-section through a noise barrier 5 in the cassette construction used in many conventional noise barriers. In this embodiment, however, the noise barrier 5 uses a combination of two sound insulation devices 1 that utilize the properties of vibroacoustic metamaterials. A sound insulation device 1 is arranged on the left-hand side of the noise barrier 5 and uses a sheet metal resonator as shown in FIGS. 10a and b. This is shown in cross-section in the enlargement at the bottom left. To allow the mechanical resonators 2 to vibrate freely, a sound insulation device is mounted on a support element 9. In addition, the sound insulation device 1 is protected from the weather and external mechanical influences by the cassette 10. On the right-hand side, the noise barrier is provided with a second sound insulation device 1. This consists of a matrix of absorption material as a spring element 4, in which mass balls 3 are embedded. This embodiment of the sound insulation device 1 utilizes mechanical resonators 2, as shown in FIG. 3d. As cassette noise barriers are usually already equipped with corresponding cavities for absorption material, the shape of the sound insulation device may be easily combined with this form of noise barrier 5. Similarly, a noise barrier in cassette construction may of course only be realized with a first sound insulation device and the second sound insulation device may be replaced by a conventional absorption material. When using two sound insulation devices 1 on opposite sides of the noise barrier 5, for example, these may be adjusted so that they reduce both the reflection of sound on the side of the noise barrier 5 facing the noise source and the transmission through the noise barrier 5 on the opposite side particularly well.

Some other forms of noise barriers 5 provided with sound insulation devices 1 are also described below.

FIG. 14a shows a noise barrier 5 in sandwich construction, which consists of two support panels 11, between which a sound insulation device 1 is arranged. As the sound insulation device 1 increases the sound absorption within the noise barrier due to its stop band, the carrier panels 11 may be thinner and lighter than the components of conventional noise barriers, or may also be made of a material with poorer sound-damping properties, such as glass. Instead, or in addition to this, the sound insulation device may also be attached to the outside of a carrier plate 11, as shown in FIG. 14b. This is particularly useful if the sound insulation device 1 is configured to reduce the transmission or reflection of sound in or from a specific direction. In order to enable a lightweight construction, a noise barrier 5, as shown in FIG. 14c, may also consist of a single carrier plate 11 to which a sound insulation device 1 is attached. In particular, the sound insulation device 1 may also be integrated into the carrier plate or manufactured together with it. A sound insulation device such as those shown in FIGS. 9a and 9b or FIGS. 10a and 10b is suitable for such a noise barrier.

A noise barrier 5 may also only be provided with a sound insulation device 1 in certain areas. For example, FIG. 15a shows a noise barrier 5 that has a solid lower portion and a thinner upper portion. However, to improve the absorption properties of the upper area, it is provided with a sound insulation device. It is also possible, as indicated in FIG. 15b, to provide an area of the noise barrier 5 with a sound insulation device 1 that is tuned to a frequency range in which this area of the noise barrier 5 is not suitable for reducing sound propagation due to its form, wall thickness or material.

FIG. 16a shows a noise barrier 5 equipped with two sound insulation devices 1 in different areas of the noise barrier 5. The two sound insulation devices 1 may be matched differently in order to compensate for differences in wall thickness, form and material of the area of the noise barrier 5 to which they are applied,

FIG. 16b shows a noise barrier 5 that is provided with a window to break through the otherwise solid form of the wall. To ensure that this window nevertheless contributes to reducing sound transmission, it is provided with a sound insulation device 1. The sound insulation device 1 may therefore be used to create more aesthetically pleasing noise barriers 5 without compromising their functionality.

The sound insulation device 1 may also be combined with other known noise protection concepts, for example with the noise barrier 5 shown in FIG. 17a with an angled attachment, which serves to influence the diffraction angle of the sound waves diffracted at the upper edge of the noise barrier 5. FIG. 17b shows a complete noise protection enclosure 12, which is provided with sound insulation devices 1 on the outside to reduce sound transmission.

Corresponding sound insulation devices 1 may also be used on other components that are intended to separate two areas spatially and acoustically. For example, such sound insulation devices may be used for passive noise protection in building façades or noise protection windows. Other possible fields of use in the construction industry include drywalling and doors. Sound insulation devices 1 may also be fitted to machine housings. Mobile noise barriers provided with sound insulation devices 1 may be used on construction sites, or corresponding movable or partition walls in open-plan offices or factories. The exemplary embodiments shown here are therefore not limiting. In particular, these exemplary embodiments may be combined with each other to achieve additional effects. It is obvious to a person skilled in the art that modifications may be made to these exemplary embodiments without departing from the fundamental principles of the subject matter of this patent application, the scope of which is defined in the claims.

1. A sound insulation device for reducing sound transmission, the sound insulation device comprising:
an arrangement of mechanical resonators, which each contain at least one vibrating mass and at least one spring element, wherein the mechanical resonators in the arrangement of mechanical resonators are each tuned such that each resonator has at least one natural frequency in a specified frequency range, and wherein the arrangement of mechanical resonators is configured such that it generates at least one stop band for attenuating propagation of waves in the specified frequency range.

2. The sound insulation device according to claim 1, wherein the arrangement of the mechanical resonators is periodic in distance in at least one dimension.

3. The sound insulation device according to claim 2, wherein a distance of the mechanical resonators from one another is smaller than a half-wavelength of a first frequency.

4. The sound insulation device according to claim 2, wherein the periodic arrangement of the mechanical resonators generates a formation of at least one further stop band for elastic wave propagation around at least one further frequency due to Bragg scattering.

5. The sound insulation device according to claim 1, wherein at least one of the arrangement of mechanical resonators resonators is such or the mechanical resonators in the arrangement of mechanical resonators are formed such that a plurality of stop bands are generated for wave propagation.

6. The sound insulation device according to claim 1, wherein individual mechanical resonators have a slightly different frequency tuning so that the at least one stop band is widened.

7. The sound insulation device according to claim 1, wherein the mechanical resonators in the arrangement of mechanical resonators each additionally comprise a damping element.

8. The sound insulation device according to claim 1, wherein the mechanical resonators in the arrangement of mechanical resonators are configured such that their frequency tuning is unable to be influenced by weather or by an external mechanical action.

9. The sound insulation device according to claim 1, wherein at least one of the mechanical resonators in the arrangement of mechanical resonators is configured as a cup resonator, wherein the cup resonator comprises an elastic membrane as the at least one spring element, which forms an outwardly closed-off cup, and a mass arranged in the outwardly closed-off cup.

10. The sound insulation device according to claim 9, wherein the outwardly closed-off cup and the mass are formed in one part.

11. The sound insulation device according to claim 9, wherein the outwardly closed-off cup and the mass are formed as individual parts and the mass is secured in the outwardly closed-off cup.

12. The sound insulation device according to claim 1, wherein at least one of the mechanical resonators in the arrangement of mechanical resonators is configured with at least one elastomer or at least one metal cushion as the at least one spring element.

13. The sound insulation device according to claim 1 wherein at least one of the mechanical resonators in the arrangement of mechanical resonators is configured with a sheet metal strip as the at least one spring element.

14. The sound insulation device according to claim 1, wherein at least one of the mechanical resonators in the arrangement of mechanical resonators is machined in one part from a surface and is defined by cutouts.

15. The sound insulation device according to claim 1, wherein at least one of the mechanical resonators in the arrangement of mechanical resonators is configured with a pre-stressed steel cable as a spring element, from which the at least one vibrating mass is suspended.

16. The sound insulation device according to claim 1, wherein at least one of the mechanical resonators in the arrangement of mechanical resonators is configured with an absorption material as a spring element, in which the at least one vibrating mass is embedded.

17. The sound insulation device according to any claim 1, wherein the mechanical resonators in the arrangement of mechanical resonators additionally comprise an element for energy conversion.

18. The sound insulation device according to claim 1, wherein the mechanical resonators in the arrangement of mechanical resonators additionally comprise an element for adjusting the at least one natural frequency.

19. A noise barrier comprising at least one sound insulation device, wherein the at least one sound insulation device includes:
an arrangement of mechanical resonators, wherein each mechanical resonator in the arrangement of mechanical resonators each contain at least one vibrating mass and at least one spring element, wherein the mechanical resonators in the arrangement of mechanical resonators are each tuned such that each resonator has at least one natural frequency in a specified frequency range, and wherein the arrangement of mechanical resonators is configured such that it generates at least one stop band for a propagation of waves in the specified frequency range.

20. The noise barrier according to claim 19, wherein the at least one sound insulation device is arranged at least in some regions on an outer side of the noise barrier.

21. The noise barrier according to claim 19, wherein the noise barrier has a sandwich structure formed from a plurality of layers, and wherein the at least one sound insulation device is arranged in an inner layer of the sandwich structure.

22. The noise barrier according to claim 19, wherein the noise barrier has a sandwich structure formed from a plurality of layers, and wherein a plurality of sound insulation devices are arranged in different layers of the sandwich structure.

23. The noise barrier according to claim 19, wherein the at least one sound insulation device is arranged in a cutout of the noise barrier.

24. The noise barrier according to claim 19, wherein the noise barrier consists of a transparent medium.

25. The noise barrier according to claim 19, wherein the at least one sound insulation device is produced permanently installed with the noise barrier.

26. A component for reducing sound propagation between two areas, comprising a sound insulation device, wherein the sound insulation device includes:
an arrangement of mechanical resonators, wherein each mechanical resonator in the arrangement of mechanical resonators each contain at least one vibrating mass and at least one spring element, wherein the mechanical resonators in the arrangement of mechanical resonators are each tuned such that each resonator has at least one natural frequency in a specified frequency range, and wherein the arrangement of mechanical resonators is configured such that it generates at least one stop band for a propagation of waves in the specified frequency range.
